(19) United States
(12) Patent Application Publication
(10) Pub. No.: US 2002/0141104 A1
(43) Pub. Date: Oct. 3, 2002

(54) Servo control method and servo control system for magnetic disc drive

(76) Inventors: Kiminori Sato, Nagano (JP); Yukihiro Takano, Kanagawa (JP)

Correspondence Address: ROSSI & ASSCOCIATES, P.O. Box 826, Ashburn, VA, 20146-0826, US

(21) Appl. No.: 10/043,082

(22) Filed: Jan. 9, 2002

(30) Foreign Application Priority Data
Jan. 9, 2001 (JP) 2001-001929

(51) Int. Cl. G11B 5/596; G11B 21/02

(52) U.S. Cl. 360/77.04; 360/75; 360/78.04

(57) ABSTRACT

A hard disc drive employs the self-servo-writing technique that writes practical servo signals on a hard disc based on the temporary servo signals written on the hard disc in advance, includes a holding mechanism that mechanically holds a rotary positioner, a memory which stores an eccentricity signal obtained while the holding mechanism is holding the rotary positioner, and a feedback compensator. The hard disc drive uses the stored eccentricity signal for a reference signal d*, calculates the difference between the reference signal d* and a head position signal x+d, obtains a positioner drive signal in the feedback compensator from the positional error based on the difference, and positions the magnetic head based on the positioner drive signal.

### FIELD OF THE INVENTION

The present invention relates to a servo control method and a servo control system for a magnetic disc drive. Specifically, the present invention relates to a servo control method and a servo control system for a magnetic disc drive which facilitates employing the self-servo-writing technique. The self-servo-writing technique uses the magnetic disc drive for writing practical servo signals on a magnetic disc installed on the magnetic disc drive based on the temporary servo signals written in advance on the magnetic disc.

### BACKGROUND

The magnetic disc drive (hereinafter referred to as the “hard disc drive”) positions the magnetic head thereof based on the servo signals written in a magnetic disc (hereinafter referred to as a “hard disc”).

FIG. 8(a) schematically shows a conventional mechanism (servo block) for positioning the magnetic head of a hard disc drive. FIG. 8(b) is a top plan for explaining the positional error of a magnetic head of the hard disc drive of FIG. 8(a). As shown in these figures, a hard disc 2 is rotated by a spindle motor 3 at several thousands rpm and such high speed. A slider 5 at the distal end of a rotary positioner 4 floats a little bit from the hard disc 2 due to the air stream on the hard disc 2. A magnetic head 6 is at the tip of the slider 5. Servo signals are written magnetically on the hard disc 2. A preamplifier 7 amplifies the servo signals. A servo signal demodulator circuit 8 demodulates the amplified servo signals to track data indicating the track, on which the magnetic head is positioning, and a position error signal (PES) indicating the deviation of the magnetic head from the center of the track. A compensator 9 obtains a driving input for driving the rotary positioner based on the difference between an objective command value r and the PES. A power amplifier 10 converts the driving input to a reference current value and drives the rotary positioner 4 based on the reference current value. Thus, the positional error between the objective track 11 and the head position is reduced by feeding back the PES. Observing on the absolute coordinates, the objective track position changes at the rotating frequency of the hard disc due to the eccentricity of the hard disc.

According to the prior art, the servo signals are written by a servo track writer (hereinafter referred to as a “STW”) on the hard disc 2 installed on the hard disc drive 1 and cramped on the spindle motor 3.

FIG. 9 is a perspective view of a conventional servo track writer. As shown in FIG. 9, the STW 12 determines the head position with a precision rotating mechanism 14 based on the scale, which the STW 12 has, while mechanically holding the rotary positioner 4 in the hard disc drive with a positioning pin 13.

The servo signals are prepared for the respective tracks. Therefore, it is necessary for the STW 12 to write the servo signals while accurately positioning the magnetic head on all the tracks on the hard disc. For improving the recording density, the number of tracks has been increased and the width of the tracks has been narrowed. Therefore, it is necessary for the STW 12 to position the magnetic head more accurately on more tracks. For realizing precise positioning, it is necessary to use a positioning mechanism with high rigidity, the manufacturing costs thereof are high. Moreover, it takes a very long time to write the servo signals. Therefore, it becomes necessary to operate a plurality of STW's in parallel, causing increase of the clean room space, therein the STW's are arranged, and increase of the manufacturing costs.

Recently, a self-servo-writing technique, which does not use any STW but uses the hard disc drive for writing the servo signals, is attracting much attention. FIG. 10 is a schematic drawing for explaining the self-servo-writing technique. As shown in FIG. 10, temporary servo signals 15 are written on a hard disc 2 in advance. By copying magnetic patterns on a master disc to the hard disc 2, for example, employing the magnetic transfer technique, the temporary servo signals are written much faster than by employing the STW. The hard disc 2 with the temporary servo signals 15 written thereon is installed on a hard disc drive and, then, the hard disc drive writes practical servo signals 16 on the hard disc 2 based on the temporary servo signals 15.

The temporary servo signals 15 are written on the hard disc 2 without combination with the actual hard disc drive. Therefore, when the hard disc 2 is chucked on the spindle motor 3 of the hard disc drive 1, the center of the recorded temporary servo signals 15 sometimes deviates from several tens to one hundred μm from the center of the spindle motor 3. The deviation is observed as the eccentricity of the tracks, which the temporary servo signals 15 form.

Since it is required that the practical servo signals be written concentrically with respect to the central axis of the spindle motor, the magnetic head should be held on a concentric circle concentric with respect to the central axis of the spindle motor. For meeting the requirement described above, it is necessary to estimate the head position based on the temporary servo signals, including the eccentricity of from several tens to one hundred μm, written in from the magnetic head 6 and to hold the magnetic head 6 not on any of the tracks formed by the temporary servo data but on any of the concentric circles concentric with respect to the central axis of the spindle motor.

As described above, the self-servo-writing technique writes temporary servo signals on a magnetic disc in advance, mounts the magnetic disc with the temporary servo signals written thereon on a hard disc drive, and makes the hard disc drive write practical servo signals on the magnetic disc based on the temporary servo signals. In writing the practical servo signals, it is necessary to read the temporary servo signals eccentric with respect to the central axis of the spindle motor by the magnetic head, to estimate the head position from the temporary servo signals read out, and to precisely hold the magnetic head not on any of the tracks formed by the temporary servo signals but on any of the concentric circles concentric with respect to the central axis of the spindle motor.

However, such a self-servo-writing technique as described above has not been well established. In other words, any practical self-servo-writing technique has not yet been realized.

In view of the foregoing, it would be desirable to provide a servo control method and a servo control system, which facilitate realizing a servo mechanism for positioning the magnetic head necessary to improve the self-servo-writing technique to a practical one.

### SUMMARY OF THE INVENTION

According to a first aspect of the invention, there is provided a servo control method for a magnetic disc drive, the magnetic disc drive including a rotary positioner and a magnetic head mounted on the rotary positioner, the servo control method employing a self-servo-writing technique, the self-servo-writing technique mounting a magnetic disc containing temporary servo signals written thereon in advance on the hard disc drive and writing practical servo signals on the magnetic disc based on the temporary servo signals, the method including: the step of preparing and the step of feedback control; the step of preparing including mechanically holding the rotary positioner, detecting the temporary servo signals to obtain an eccentricity signal, and storing the obtained eccentricity signal as a reference signal; and the step of feedback control including releasing the rotary positioner from the mechanically holding thereof, feeding back a head position signal indicating the position of the magnetic head, obtaining the difference between the eccentricity signal and the head position signal, and positioning the rotary positioner on a concentric circle based on the obtained difference.

Advantageously, the step of feedback control includes positioning the rotary positioner based on an objective command value indicating the objective position of the magnetic head.

According to a second aspect of the invention, there is provides a servo control system for a magnetic disc drive, the magnetic disc drive including a rotary positioner and a magnetic head mounted on the rotary positioner, the servo control system employing a self-servo-writing technique, the self-servo-writing technique mounting a magnetic disc containing temporary servo signals written thereon in advance on the hard disc drive and writing practical servo signals on the magnetic disc based on the temporary servo signals, the servo control system including: a holding means, a memory means and a feedback control means; the holding means holding the rotary positioner mechanically at a certain position; the memory means storing an eccentricity signal obtained by detecting the temporary servo signals as a reference signal while the holding means is holding the rotary positioner mechanically; the feedback control means feeding back a head position signal indicating the position of the magnetic head after releasing the rotary positioner from the mechanically holding thereof to obtain the difference between the eccentricity signal and the head position signal, and the feedback control means positioning the rotary positioner on a concentric circle based on the obtained difference.

Advantageously, the feedback control means positions the rotary positioner based on an objective command value indicating the objective position of the magnetic head.

According to a third aspect of the invention, there is provided a servo control method for a magnetic disc drive, the magnetic disc drive including a rotary positioner and a magnetic head mounted on the rotary positioner, the servo control method employing a self-servo-writing technique, the self-servo-writing technique mounting a magnetic disc containing temporary servo signals written thereon in advance on the hard disc drive and writing practical servo signals based on the temporary servo signals, the method including: the step of state estimation and the step of feedback control; the step of state estimation including estimating the relative position of the magnetic head with respect to the temporary servo signals and the absolute speed of the magnetic head on the magnetic disc based on a signal inputted to the rotary positioner and a detected position signal indicating the detected position of the rotary positioner; the step of feedback control including feeding back the data indicating the relative position and the absolute speed obtained in the step of state estimation to the driving system of the rotary positioner to position the rotary positioner on a concentric circle.

Advantageously, the step of state estimation includes setting the feedback gain at a value large enough for the influence of the eccentricity of the magnetic disc mounted on the hard disc drive to be negligible such that the relative position and the absolute speed of the magnetic head are estimated accurately.

According to a fourth aspect of the invention, there is provided a servo control system for a magnetic disc drive, the magnetic disc drive including a rotary positioner and a magnetic head mounted on the rotary positioner, the servo control system employing a self-servo-writing technique, the self-servo-writing technique mounting a magnetic disc containing temporary servo signals written thereon in advance on the hard disc drive and writing practical servo signals on the magnetic disc based on the temporary servo signals, the servo control system including: a state estimating means and a feedback control means; the state estimating means estimating the relative position of the magnetic head with respect to the temporary servo signals and the absolute speed of the magnetic head based on a signal inputted to the rotary positioner and a detected position signal indicating the detected position of the rotary positioner; the feedback control means feeding back the data indicating the relative position and the absolute speed obtained by the state estimating means to the driving system of the rotary positioner to position the rotary positioner on a concentric circle.

Advantageously, the state estimating means exhibits a feedback gain large enough for the influence of the eccentricity of the magnetic disc mounted on the hard disc drive to be negligible such that the relative position and the absolute speed of the magnetic head are estimated accurately.

### BRIEF DESCRIPTION OF THE DRAWINGS

The invention will now be described in greater detail with reference to the following detailed description of the preferred embodiments of the invention and the accompanying drawings, wherein:

FIGS. 1(a) and 1(b) schematically show a mechanism (servo block) for positioning the magnetic head of a hard disc drive according to a first embodiment of the invention;

FIG. 2 is a diagram of the servo block according to the first embodiment of the invention;

FIG. 3 is a simulation model of the servo block according to the first embodiment of the invention;

FIGS. 4(a) and 4(b) describe the results of simulation by the servo simulation model according to the first embodiment of the invention;

FIG. 5 is a diagram of a servo block diagram according to the second embodiment of the invention;

FIG. 6 is a simulation model of the servo block according to the second embodiment of the invention;

FIGS. 7(a) and 7(b) describe the results of simulation by the servo simulation model according to the second embodiment of the invention;

FIG. 8(a) schematically shows a conventional mechanism (servo block) for positioning the magnetic head of a hard disc drive;

FIG. 8(b) is a top plan for explaining the positional error of a magnetic head of the hard disc drive of FIG. 8(a);

FIG. 9 is a perspective view of a conventional servo track writer; and

FIG. 10 is a schematic drawing for explaining the self-servo-writing technique.

### DETAILED DESCRIPTION OF THE PREFERRED EMBODIMENTS OF THE INVENTION

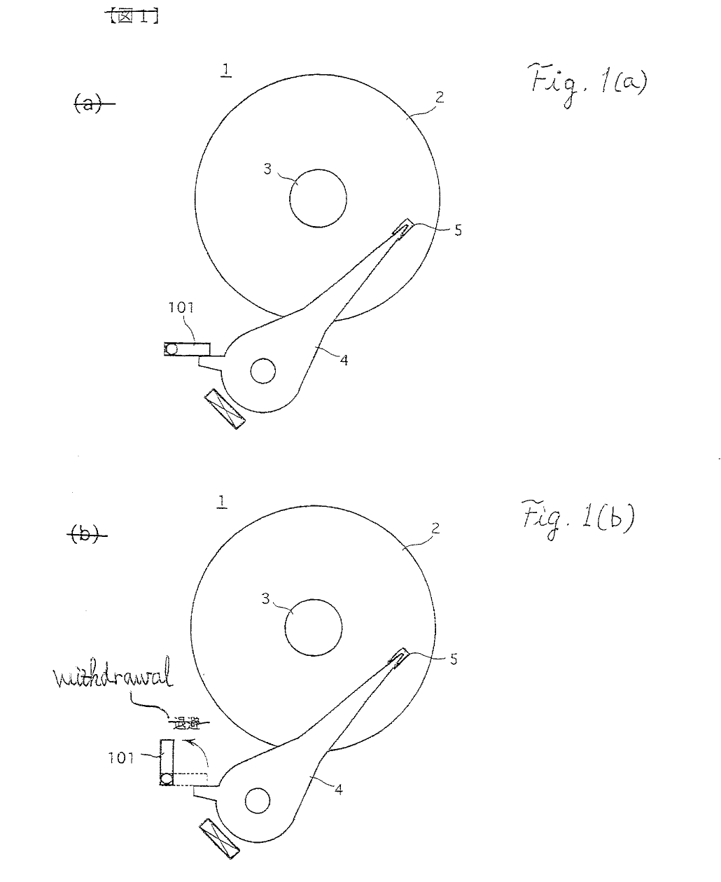

FIGS. 1(a) and 1(b) schematically show a mechanism (servo block) for positioning the magnetic head of a hard disc drive according to a first embodiment of the invention.

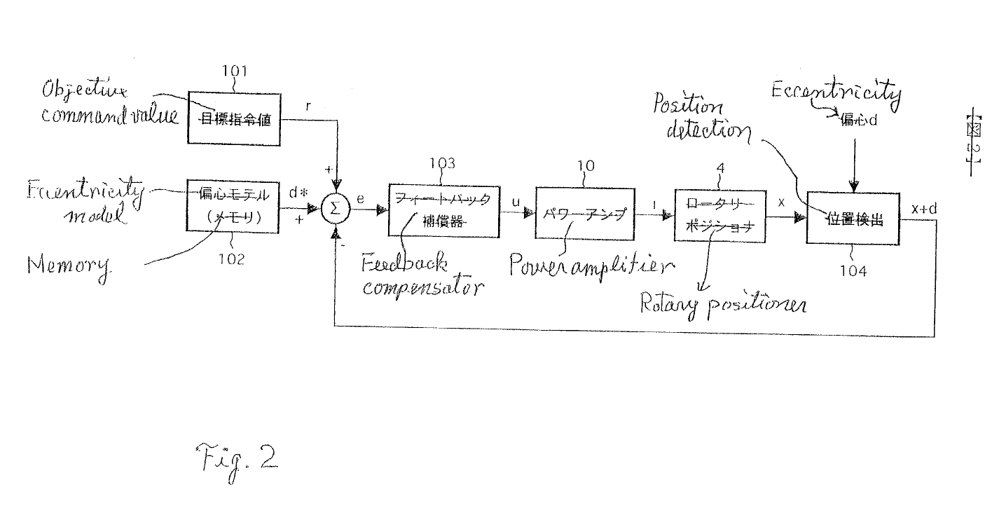

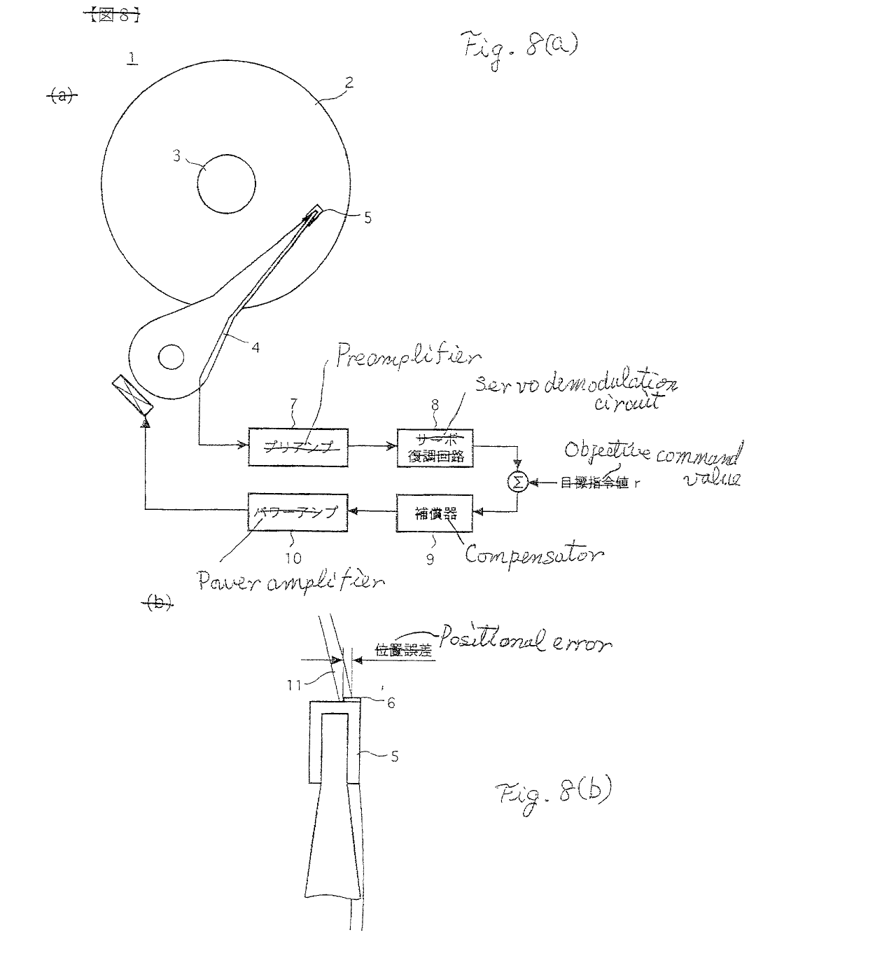

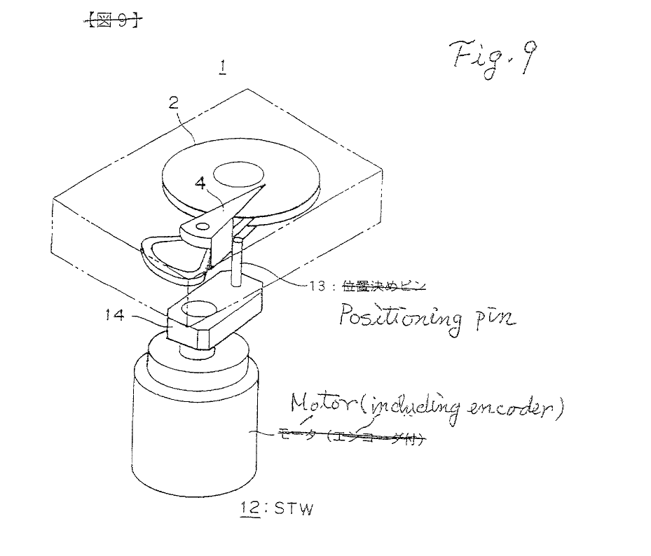

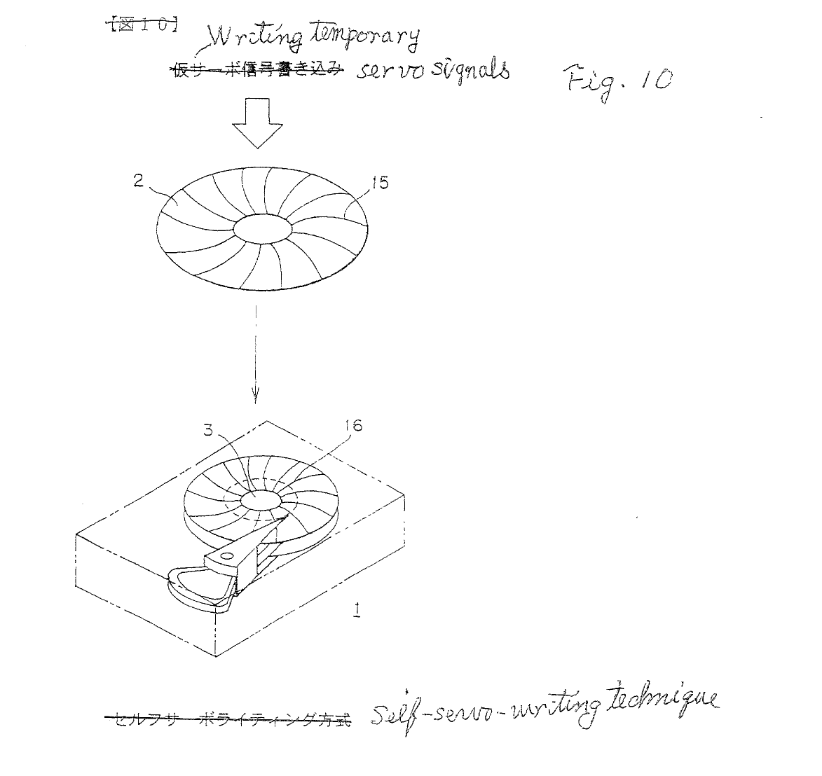

Referring now to FIG. 1(a), a track locating mechanism according to the first embodiment includes a rotary positioner holding mechanism 101 which mechanically holds the rotary positioner 4. More specificallyl, the hard disc drive 1 is started, and the slider 5 is mounted on the hard disc drive 1. Then, the magnetic head 6 is held at an arbitrary position on the hard disc 2 with the rotary positioner holding mechanism 101. While the rotary positioner holding mechanism 101 is holding the slider 5, temporary servo signals 15 (FIG. 10) are read out, the eccentricity of the hard disc 2 due to chucking of the disc and such causes is measured, and the measured eccentricity is stored in a memory 102 (FIG. 2). The eccentricity of the hard disc 2 is obtained from the track data and the PES obtained by the servo demodulation circuit 8 (FIG. 8(a)). Then, the rotary positioner holding mechanism 101 is withdrawn to make the rotary positioner free as shown in FIG. 1(b), and the servo operation is started.

FIG. 2 is a diagram of the servo block according to the first embodiment of the invention. The transfer function of the rotary positioner 4 is described by the following equation (1).

G(s)=K×(1/s²−1/(s²+2·ζ·wₙ·s+wₙ²)) (1)

K=K_{AMP}×Kₜ×Rₕ/J

Here, K_{AMP} is the gain of the power amplifier, Kₜ the torque/current constant, Rₕ the arm length of the rotary positioner, and J the moment of inertia of the rotary positioner.

The first term of the equation (1) represents the nominal transfer function from the control input signal to the head position, and the second term the higher order resonance model. (When a higher order resonance of 15 db exists at 1.2 kHz, ζ is 0.0893 and wₙ is 7600.7.)

Using the eccentricity measured and stored in advance as a reference eccentricity signal (eccentricity model), the magnetic head is positioned by feeding back the difference between the head position signal and the reference eccentricity signal (eccentricity model). A feedback compensator 103 is a phase lead compensator, which obtains the control input signal to the rotary positioner 4 from the above described difference. A position detector 104 reads out the position signal written on the hard disc using the magnetic head 6 at the tip of the rotary positioner 4 (FIGS. 8(b) and 8(b)) and detects the head position (=x+d) based on the read out position signal.

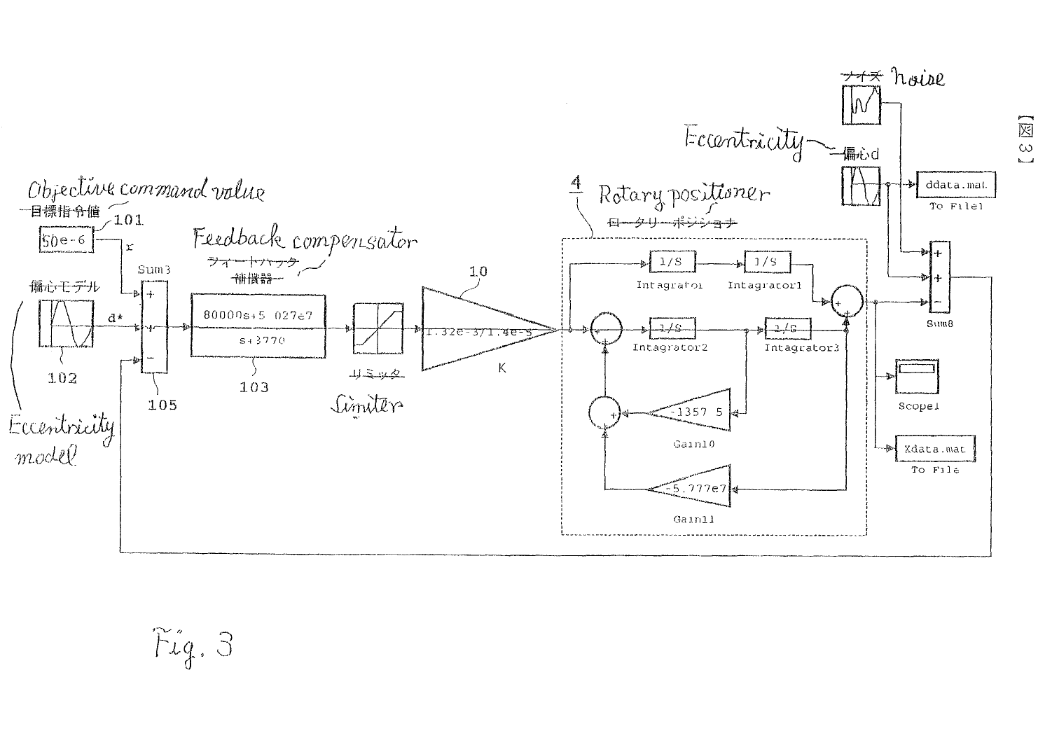

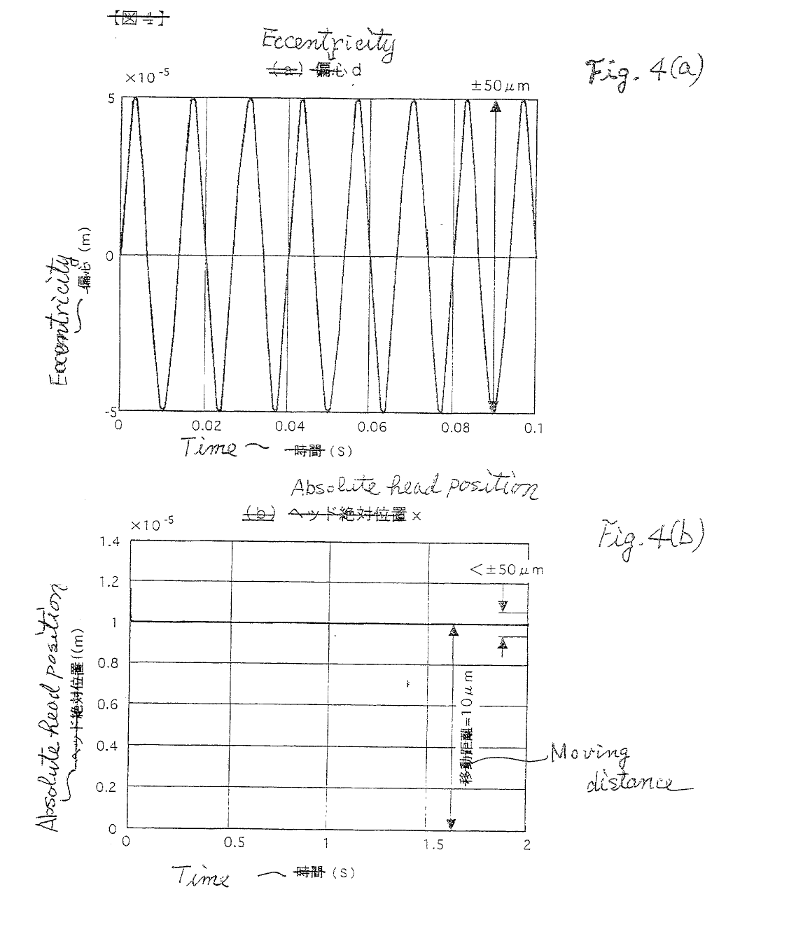

FIG. 3 is a simulation model of the servo block shown in FIG. 2. FIGS. 4(a) and 4(b) describe the results of simulation by the simulation model described in FIG. 3.

The position signal obtained by the magnetic head 6 is a relative head position y with respect to the temporary servo signals. The relative head position y is equal to the sum of the absolute head position x and the actual eccentricity d. The position of the magnetic head 6 is determined by subtracting the relative head position signal from the reference eccentricity signal (eccentricity model) d* and by obtaining the rotary positioner drive signal from the difference (d*−d)−x in the feedback compensator 103.

The objective command value r is inputted to the same point, wherein the reference eccentricity signal (eccentricity model) d* is inputted. (In FIG. 3, 50 μm (50e-6) is inputted for the objective command value.) As FIGS. 4(a) and 4(b) indicate, the magnetic head 6 is held on a concentric circle (with the accuracy of ±0.5 μm) even when the eccentricity d of ±50 μm is involved.

The servo control according to the first embodiment of the invention employs the self-servo-writing technique which installs a hard disc, thereon temporary servo signals are written, on a hard disc drive, and makes the hard disc drive write practical servo signals on the hard disc based on the temporary servo signals. The servo control system according to the first embodiment includes a holding mechanism which mechanically holds the rotary positioner, a memory which stores the eccentricity signal obtained while the holding mechanism is holding the rotary positioner as a reference signal, and a feedback compensator. According to the first embodiment, the positional error between the stored eccentricity signal (reference signal) and the head position signal is obtained, the positioner drive signal is obtained based on the obtained positional error by the feedback compensator, and the magnetic head is positioned based on the positioner drive signal. According to the first embodiment, the practical servo signals are written from the magnetic head 6 held on a concentric circle even when the eccentricity of ±50 μm is involved in the tracks formed by the temporary servo signals.

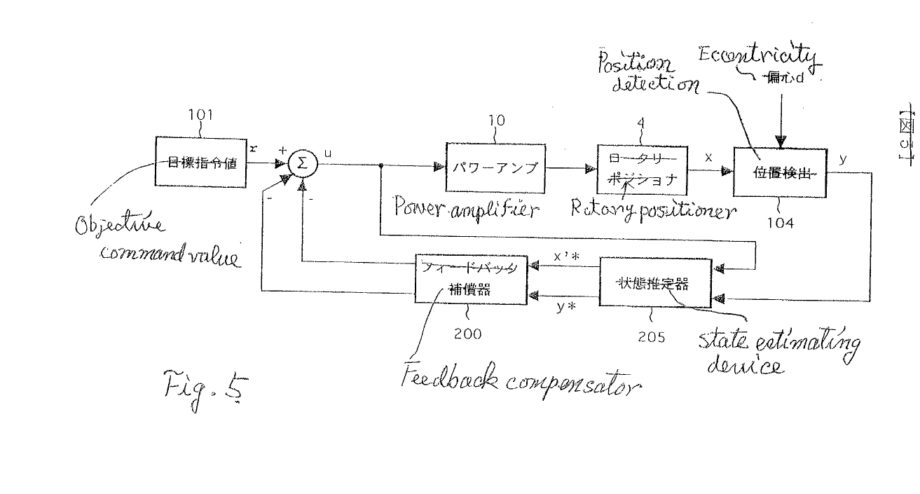

FIG. 5 is a diagram of a servo block diagram according to a second embodiment of the invention. Referring now to FIG. 5, a state estimating device 205 estimates an estimated relative position y* and an estimated absolute speed of the head x′*. A feedback compensator 200 obtains a control input signal to the rotary positioner 4 from the estimated quantities of state [x′y]^{t}.

Now the state estimating device 205 is described in detail. The nominal rotary positioner model is described by the following equation of motion (2).

d²x/dt²=K_{AMP}·RₕKₜ/J×u (2)

The position signal obtained by the magnetic head is the relative head position y with respect to the temporary servo signals. The relative head position y and the absolute head position x are related with each other by the following equation (3).

y=x+d (3)

If one puts the state variable Z in [x′y]^{t}, the state variable Z will be expressed by the following equation (4).

dZ/dt=AZ+BU+QW (4)

Here, U is the control system input, which is [u], W is the disturbance, which is [d′], wherein d′ is the differentiation of the eccentricity with time, and A, B and Q are matrices described below.

$$A = \vert \begin{matrix}0 & 0 \\ 1 & 0\end{matrix} \vert$$

$$B = \vert \begin{matrix}{K}_{AMP} \cdot {R}_{h} \cdot {K}_{t} / J \\ 0\end{matrix} \vert$$

$$Q = \vert \begin{matrix}0 \\ 1\end{matrix} \vert$$

If one assumes that the control system output Y is equal to the state variable Z, the following equation (5) is obtained.

$$Y = C \cdot Z \\ \begin{matrix} & 1 & 0 \\ & & \\ & & \end{matrix} \\ \begin{matrix}C = & & \\ & 0 & 1 \\ & & \end{matrix} \qquad ( 5 )$$

The state estimating device 205 estimates the state variable Z based on the following equation (6).

dZ*/dt=A·Z*+B·U+Q·W+L·(Y−C·Z*)=(A−L·C)·Z*+B·U+L·Y+Q·W (6)

Here, Z* is the estimated value of Z, and L is the gain of estimation of the state estimating device 205 which is a matrix of 2×1.

By putting the difference Z\mathring{} between the equation (4) and the equation (5) in Z\mathring{}=Z−Z*, the following equation (7) is obtained.

dZΛ/dt=(A−L·C)·ZΛ+Q·W (7)

Equation (7) is an error estimation equation, which includes a noise term Q·W. Since the matrices C and Q are of the same order, estimation is made by setting the gain of estimation L at a sufficiently large value such that L·Z\mathring{}>>W while minimizing the error caused by the noise term Q·W.

Now the operation of the state estimating device 205 is explained form another view point. If one puts the state variable X in [x′x]^{t}, the equation of state of the rotary positioner is the following equation (8).

dX/dt=A·X+B·U (8)

The control system input U, and the matrices A and B are described below.

U=[u]

$$A = \vert \begin{matrix}0 & 0 \\ 1 & 0\end{matrix} \vert$$

$$B = \vert \begin{matrix}{K}_{AMP} \cdot {R}_{h} \cdot {K}_{t} / J \\ 0\end{matrix} \vert$$

State feedback is realized by multiplying the output Z* of the state estimating device and the feedback gain. The following equation (9) is obtained by substituting −K_{f}·Z* for U in equation (8).

dX/dt=A·X−B·K_{f}·Z*=(A−B·K_{f})·X+B·K_{f}·D (9)

Here, D=[0d]^{t} is the disturbance term.

Now equation (7) and equation (9) are compared with each other. In equation (7), the error caused by the noise term Q·W is minimized by setting the feedback gain L of the state estimating device such that L·Z>>W, since L and Q can be set independently. In equation (9), it is not so advantageous to set the feedback gain of the control system at a large value, since the noise term (B·K_{f}·D) becomes large when K_{f} is set at a large value.

One guideline is to set the feedback gain L of the state estimating device at a value large enough to meet the condition L·Z>>W and the feedback gain K of the control system at a value smaller than the ratio A/B between the system matrix A and the input matrix B.

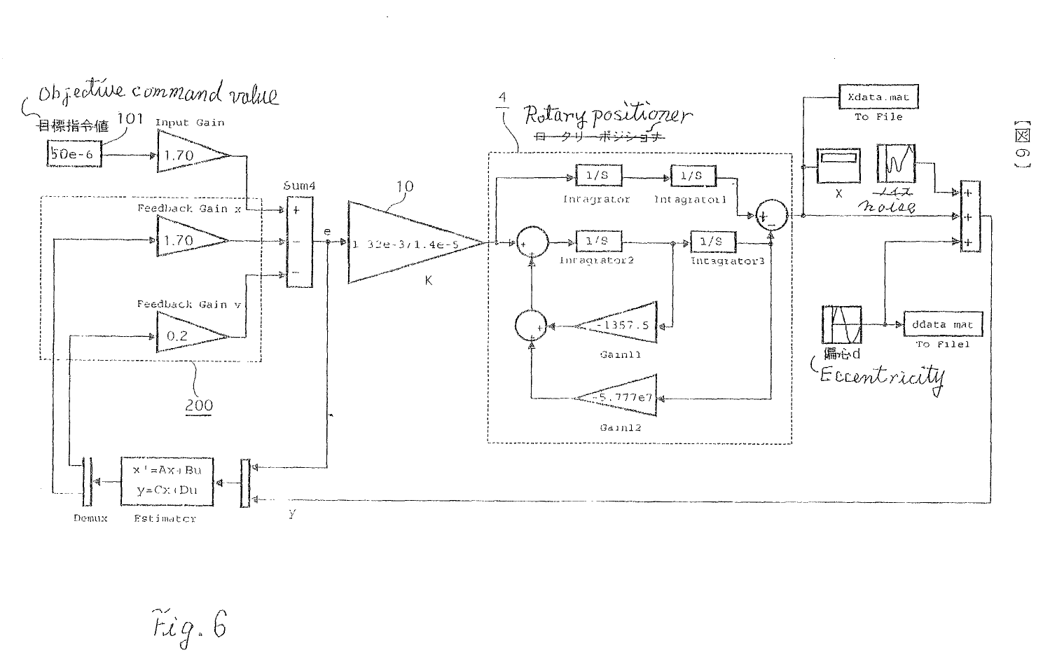

FIG. 6 is a simulation model of the servo block of FIG. 5. The relative head position signal y with respect to the temporary servo signals is equal to the sum of the positional error signal of the rotary positioner and the eccentricity d. The feedback control is conducted based on the product of y* obtained by the state estimating device and the compensation gain and the product of the estimated speed value x′* and the compensation gain. The position feedback gain of the feedback compensator, the speed feedback gain of the feedback compensator, and the feedback gain of the state estimating device are determined by the pole assignment method.

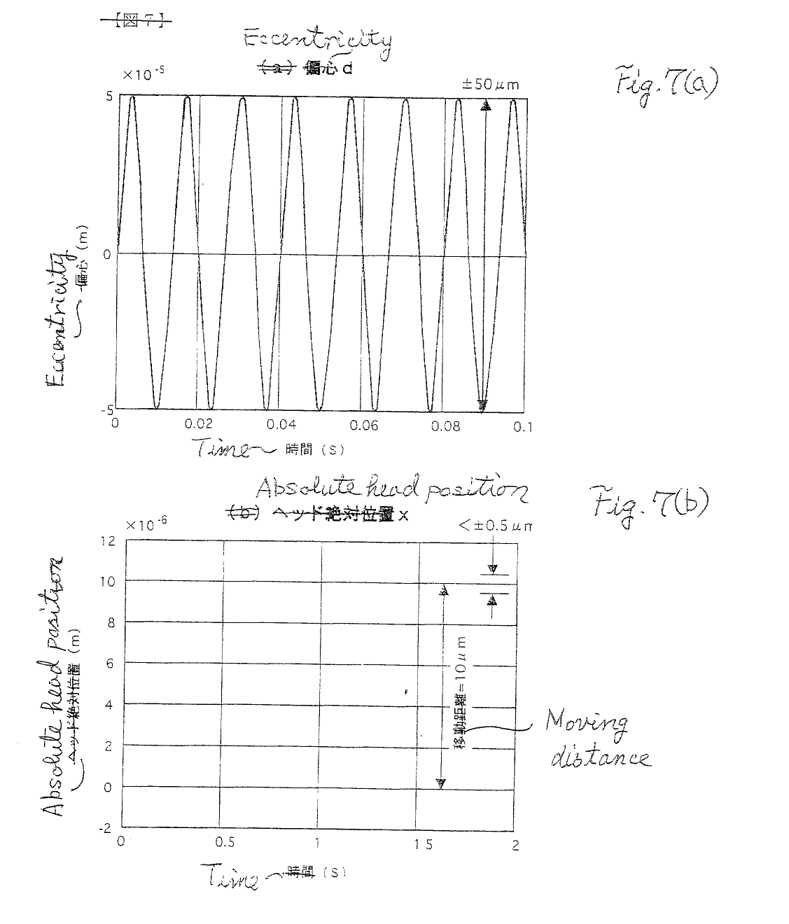

In the simulation model described in FIG. 6, the feedback gain K_{f} of the feedback compensator is K_{f}=[Speed feedback gain, Position feedback gain]=[0.2, 1.7], and the gain of estimation L of the state estimating device is L=[1000, 2000]. As described in FIGS. 7(a) and 7(b), the magnetic head 6 is positioned on a concentric circle (with the accuracy of ±0.5μm) using the servo signals containing the eccentricity of ±50 μm.

Although the response of the servo control according to the second embodiment is slower than the response of the servo control according to the first embodiment, the servo control according to the second embodiment facilitates estimating and feeding back the absolute head speed x′ of the rotary positioner precisely and positioning the magnetic head at the tip of the rotary positioner on a concentric circle. Moreover, it is not necessary for the servo control according to the second embodiment to use the means for measuring the eccentricity and for storing the measured eccentricity including the rotary positioner holding mechanism and the memory for storing the eccentricity signal, which the servo control according to the first embodiment uses.

The servo control according to the second embodiment of the invention employs the self-servo-writing technique, which installs a hard disc, thereon temporary servo signals are written, on a hard disc drive, and makes the hard disc drive write practical servo signals on the hard disc based on the temporary servo signals. The servo control system according to the second embodiment includes a state estimating device which estimates the relative head position and the absolute head speed of the rotary positioner with respect to the temporary servo signals. By virtue of the large feedback gain thereof, the state estimating device facilitates reducing the adverse effect of the eccentricity and estimating the relative head position and the absolute head speed very accurately. The servo control according to the second embodiment, which feeds back the relative head position and the absolute head speed, facilitates positioning the magnetic head on a concentric circle based on the temporary servo signal even when the eccentricity of ±50 μm is involved in the tracks formed by the temporary servo signal and writing the practical servo signals from the magnetic head precisely positioned.

As described above, the present invention facilitates realizing a servo mechanism for positioning the magnetic head, which is necessary to develop the so-called self-servo-writing technique.

The servo control according to the invention is applicable not only to the servo mechanism of the hard disc drive which conducts serf servo writing but also to the servo tester for evaluating the servo characteristics based on the temporary servo signals as disclosed in Japanese Unexamined Laid Open Patent Application No. H 11 (1999)-290264.

What is claimed is:

1. A servo control method for a magnetic disc drive, the magnetic disc drive including a rotary positioner and a magnetic head mounted on the rotary positioner, the servo control method employing a self-servo-writing technique, the self-servo-writing technique mounting a magnetic disc containing temporary servo signals written thereon in advance on the disc drive and writing practical servo signals on the magnetic disc based on the temporary servo signals, the method comprising:
mechanically holding the rotary positioner;
detecting the temporary servo signals to obtain an eccentricity signal;
storing the obtained eccentricity signal as a reference signal;
releasing the rotary positioner from the mechanically holding thereof,
feeding back a head position signal indicating a position of the magnetic head;
obtaining a difference between the eccentricity signal and the head position signal; and
positioning the rotary positioner on a concentric circle based on the obtained difference.

2. The servo control method according to claim 1, further comprising positioning the rotary positioner based on an objective command value indicating an objective position of the magnetic head.

3. A servo control system for a magnetic disc drive, the magnetic disc drive including a rotary positioner and a magnetic head mounted on the rotary positioner, the servo control system employing a self-servo-writing technique, the self-servo-writing technique mounting a magnetic disc containing temporary servo signals written thereon in advance on the disc drive and writing practical servo signals on the magnetic disc based on the temporary servo signals, the servo control system comprising:
a holding means for holding the rotary positioner mechanically at a certain position;
a memory means for storing an eccentricity signal obtained by detecting the temporary servo signals as a reference signal while the holding means is holding the rotary positioner mechanically; and
a feedback control means for feeding back a head position signal indicating a position of the magnetic head after releasing the rotary positioner from the mechanically holding thereof and obtaining a difference between the eccentricity signal and the head position signal, wherein the rotary positioner is positioned on a concentric circle based on the obtained difference.

4. The servo control system according to claim 3, wherein the feedback control means positions the rotary positioner based on an objective command value indicating an objective position of the magnetic head.

5. A servo control method for a magnetic disc drive, the magnetic disc drive including a rotary positioner and a magnetic head mounted on the rotary positioner, the servo control method employing a self-servo-writing technique, the self-servo-writing technique mounting a magnetic disc containing temporary servo signals written thereon in advance on the disc drive and writing practical servo signals on the magnetic disc based on the temporary servo signals, the method comprising:
estimating a relative position of the magnetic head with respect to the temporary servo signals and an absolute speed of the magnetic head based on a signal inputted to the rotary positioner and a detected position signal indicating a detected position of the rotary positioner;
feeding back data indicating the relative position and the absolute speed to a driving system of the rotary positioner to position the rotary positioner on a concentric circle.

6. The servo control method according to claim 5, wherein a feedback gain is set at a value large enough for an influence of the eccentricity of the magnetic disc mounted on the hard disc drive to be negligible.

7. The servo control method according to claim 5, further comprising positioning the rotary positioner based on an objective command value indicating an objective position of the magnetic head.

8. A servo control system for a magnetic disc drive, the magnetic disc drive including a rotary positioner and a magnetic head mounted on the rotary positioner, the servo control system employing a self-servo-writing technique, the self-servo-writing technique mounting a magnetic disc containing temporary servo signals written thereon in advance on the disc drive and writing practical servo signals on the magnetic disc based on the temporary servo signals, the servo control system comprising:
estimating, with a state estimating mechanism, a relative position of the magnetic head with respect to the temporary servo signals and an absolute speed of the magnetic head based on a signal inputted to the rotary positioner and a detected position signal indicating a detected position of the rotary positioner;
feeding back data, with a feedback control mechanism, indicating the relative position and the absolute speed obtained by the state estimating means to a driving system of the rotary positioner to position the rotary positioner on a concentric circle.

9. The servo control system according to claim 8, wherein the state estimating mechanism exhibits a feedback gain large enough for an influence of the eccentricity of the magnetic disc mounted on the hard disc drive to be negligible.

10. The servo control system according to claim 8, wherein the feedback control mechanism positions the rotary positioner based on an objective command value indicating an objective position of the magnetic head.
